(19) United States
(12) Patent Application Publication
(10) Pub. No.: US 2003/0077507 A1
(43) Pub. Date: Apr. 24, 2003

(54) Rechargeable battery

(75) Inventor: Markus Hoh, Rheine (DE)

Correspondence Address: SCHNADER HARRISON SEGAL & LEWIS, LLP, 1600 MARKET STREET, SUITE 3600, PHILADELPHIA, PA, 19103

(73) Assignee: NBT GmbH

(21) Appl. No.: 10/272,604

(22) Filed: Oct. 16, 2002

(30) Foreign Application Priority Data
Oct. 18, 2001 (DE) DE 101 51 604.5

(51) Int. Cl. H01M 2/10; H01M 10/50

(52) U.S. Cl. 429/120; 429/96

(57) ABSTRACT

A rechargeable battery includes a number of electrochemical storage cells arranged in a common battery box, with intermediate spaces, which are in the form of columns and are provided between the storage cells, for a cooling medium. The battery box has a number of side inlet openings located one above the other, for the cooling medium. The side inlet openings have different areas or are at different distances from one another. The battery box has side inlet openings on at least two opposite sides, and air is used as the cooling medium.

### RELATED APPLICATION

This invention claims priority of German Patent Application No. DE 101 51 604.5, filed Oct. 18, 2001.

### FIELD OF THE INVENTION

This invention relates to a rechargeable battery having a number of electrochemical storage cells, which are arranged in a common battery box, with intermediate spaces, which are in the form of columns and are provided between the storage cells, for a cooling medium.

### BACKGROUND

During operation of rechargeable battery cells, which operate in a battery assembly and are accommodated in a common battery box, unavoidable heat losses can lead to considerable heating of the system. In this case, temperature levels can be reached which can cause damage to the cell components, and possibly also to the active materials, and can at least initiate noticeable changes in the electrical behavior of the cells. For this reason, cooling of such a system is essential.

In particular, discrepancies can occur in the interaction of the cells—in the case of relatively large battery assemblies, in a corresponding manner in the modules as well—if they are not cooled uniformly. Since the current drawn and the current emitted depend on the temperature, non-uniformly cooled cells have capacities of different size and, therefore, do not all become completely discharged at the same time.

In the case of cells which are accommodated in the large container or battery box, as is the case in particular with traction batteries for electric vehicles, cooling is carried out only to a lesser extent by heat radiation. In fact, the cells must be cooled by forced convection by means of a coolant flow, preferably an air flow. In order that the coolant can reach the individual cells or cell modules, these must be installed at a distance from one another in the container. In this case, the shape and equipment of the container, the inlet and outlet opening fro the cooling air and the fans that are provided must satisfy the requirements for the cooling power.

However, most known cooling devices are designed for a relatively large cell assembly and do not provide uniform cooling power for the individual cells. Normally, cooling air is passed along a relatively long row of cells, with those cells located at the front in the sequence coming into contact with the fresh cooling medium, while the subsequent cells come into contact with the cooling medium which has already been heated. In consequence, the average temperature of the cells located at the front of the sequence is also lower than that of the subsequent ones.

The cooling power is thus staggered, corresponding to the arrangement of the cell in the air flow. The staggering of the cooling power falls more linearly the more exactly the cooling medium is passed from cell to cell. The same applies to the staggering of the average temperatures which occur in the cells.

As is known, for example, from DE 4029018 A1, non-uniformity of the cooling effect can be reduced by providing branches in the cooling airflows. However, it cannot be prevented. If the coolant flow runs parallel to the longitudinal axis of the cell modules, there will also be a temperature gradient in this direction. As long as the same coolant flows successively to the cells, this will result in a nonuniform temperature distribution.

This concept is also adopted with the various measures for heat dissipation from a high-energy battery according to DE 4029901 A1.

According to EP 0918358 A1 and EP 0964470 A1, more uniform heat dissipation from the cells can be achieved by partial heat-compartmentalization of the battery surface of better-cooled cells, and by speeding up the coolant flow for cells which are cooled less well.

In De 2835501 C2, uniform cooling of the cell modules is achieved by providing intermediate spaces as coolant channels between the modules, with the supply channel having a cross section which tapers downstream, and the collecting channel for the heated cooling medium having a cross section which widens downstream.

DE 4116253 A1 uses a similar cooling method in which branches are provided in the airflow by arranging the individual cells in the form of a staircase such that each cell is supplied with a partial flow of fresh cooling medium. Equal volumes flow to all the cells since the flow resistance is the same in each air channel, and the cooling conditions are the same.

U.S. Pat. No. 5,015,545 achieves the same effect by oblique positioning of two rows of prismatic cell modules arranged one above the other. The tapering air gap between the module rows results in the speed of the air flows increasing in inverse proportion to the increase in temperature. This results in uniform cooling power for the individual cells.

On the one hand, DE 10064648 A1 discloses the construction according to DE 2835501 A1. On the other hand, it is proposed that the cells, or the cell modules which are mounted in a row, be arranged in a staggered form. The interior of the stagger forms the supply channel for the cooling medium.

The described designs require large supply channels. The large rechargeable battery volume associated with this is not acceptable for every application since this reduces the energy content per unit volume.

In EP 0639867 A1, a uniform cell module temperature is achieved by means of reverse cooling. The installation of fans which can pivot or of switchable coolant channels, as is required for this purpose, makes the solution complex and expensive.

It would therefore be advantageous to provide a means of achieving uniform cooling for rechargeable batteries.

### SUMMARY OF THE INVENTION

This invention relates to a rechargeable battery including a battery box, a plurality of electrochemical storage cells arranged in the battery box to form intermediate spaces, in the form of columns, to facilitate passage of a cooling medium to flow between the storage cells, the battery box having a plurality of side inlet openings located one above the other, for the cooling medium to flow into the box.

### BRIEF DESCRIPTION OF THE DRAWINGS

The invention will be described in more detail in the following text with reference to the Figures, in which:

FIG. 1 is a schematic perspective view of a rechargeable battery in accordance with aspects of the invention;

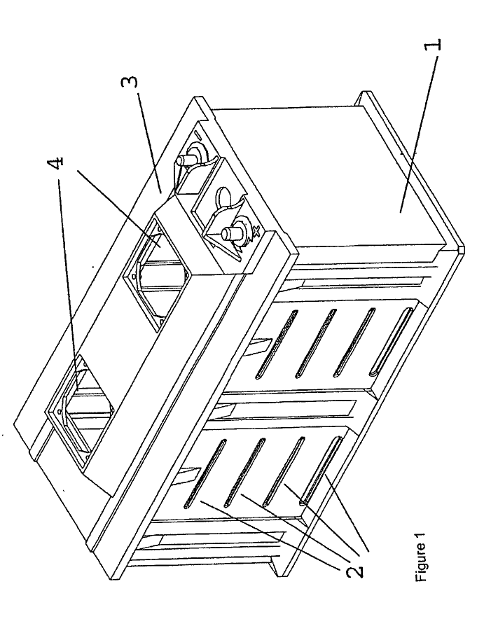

FIG. 2 is a schematic perspective view of a battery box in accordance with aspects of the invention; and

FIG. 3 is a schematic perspective view of a battery cover in accordance with aspects of the invention.

### DETAILED DESCRIPTION

It will be appreciated that the following description is intended to refer to specific embodiments of the invention selected for illustration in the drawings and is not intended to define or limit the invention, other than in the appended claims.

The rechargeable battery according to the invention, in particular a nickel/metal hydride battery, has a battery box 1 which has a number of side inlet openings 2 located one above the other, for the cooling medium or fluid, in particular, air. As a consequence, the cooling medium no longer flows to the cells exclusively successively or individually since the appropriately designed side inlet openings 2 result in it being supplemented by fresh cooling medium as required. Further temperature uniformity can be achieved by deliberate control of the proportion of the cooling medium which flows in and then up through the lower inlet openings, for example, by means of an additional plate with openings for the cooling medium underneath the cells.

The battery box 1 and the battery cover 3 are preferably manufactured from an impact-resistant plastic, for example, polypropylene to the standard dimensions for starter batteries. Electrochemical energy stores are arranged alongside one another and one behind the other in rows in these battery boxes. By way of example, a large number of round cells are arranged alongside one another and one above the other in the longitudinal direction of the battery box, with intermediate spaces being left free. A number of round cells may likewise in each case be located one behind the other in the longitudinal direction. The electrochemical energy stores may preferably be nickel/metal hydride round cells with wound electrodes, which are mounted lying parallel to the longitudinal sides of the battery box 1. Gaps in the form of columns are located between the individual cells, so that a cooling medium can flow around their housings. It is particularly advantageous for the cells located adjacent to the outer walls to be installed with only a small gap, or without any gap, from the outer wall.

Liquids such as water, oil or glycol, and gases, are suitable for the cooling medium, since they come into contact only with the sealed housings of the cells. However, the preferred coolant is air which is sucked or forced through the battery box I by at least one fan.

The battery cover 3 of the battery box 1 is preferably appropriately shaped for installation of electrical fans. The fans suck the air into the battery box 1 through the side inlet openings 2, and pass it along the cells, sucking out the heated air to the exterior through outlet openings 4 in the battery cover 3. The inlet openings 2 may have any desired shape, and they produce a flow of additional coolant which decreases toward the outlet openings 4. This may advantageously be achieved by reducing the ratio of the proportion of the area of the inlet opening 2 to the proportion of the external area in the direction of the outlet opening 4. The inlet openings 2 may have different areas, and/or may be at different distances from one another. With regard to the power supply for the fans, it is particularly advantageous to provide this from the battery that is to be cooled. Since direct current is available from the battery, direct current motors are provided for driving the fans.

The inlet openings 2, which are preferably in the form of slots, for the cooling air can be seen on the longitudinal sides of the battery box 1. The lowest inlet opening 2 for the cooling air is the main opening with the largest area. Two outlet openings 4 are integrated in the battery cover, and sucking fans can advantageously be installed in them. In a similar way to a conventional starter battery, end poles are provided in the rechargeable battery, for connection to an electrical supply network.

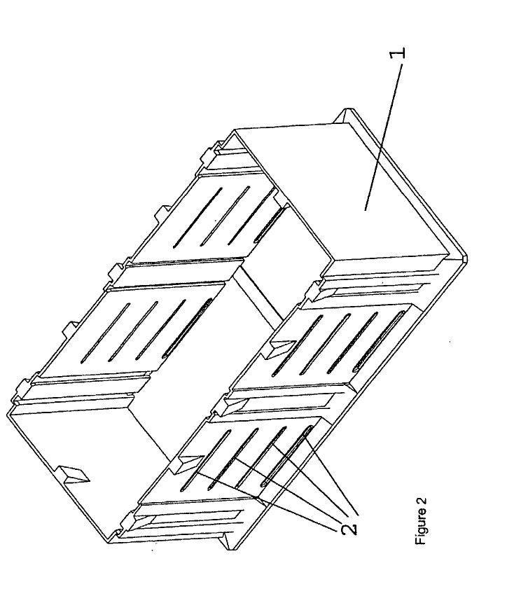

FIG. 2 shows a view into the open new battery box 1, which has side inlet openings on at least two opposite sides. In the preferred embodiment, inlet openings 2 in the form of slots are provided on both longitudinal sides.

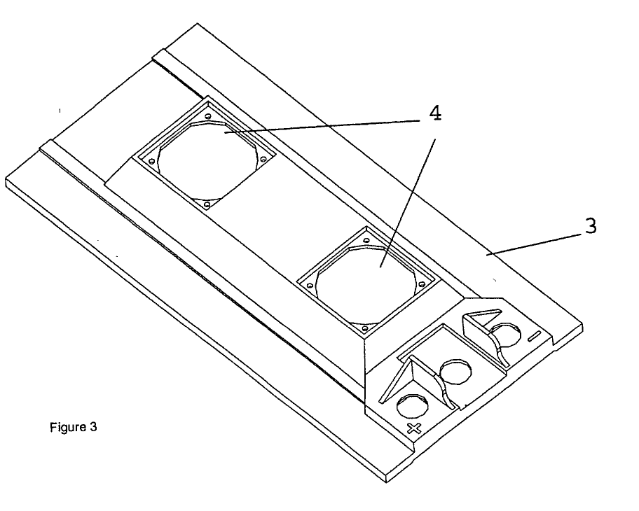

FIG. 3 illustrates the battery cover with two outlet openings 4, which are prepared for the installation of sucking fans. Openings for additional taps for supply purposes or for monitoring the rechargeable battery may also be integrated in the design of the battery cover 3, in addition to the openings for the two end poles.

1. A rechargeable battery comprising:
a battery box;
a plurality of electrochemical storage cells arranged in the battery box to form intermediate spaces, in the form of columns, to facilitate passage of a cooling medium to flow between the storage cells, the battery box having a plurality of side inlet openings located one above the other, for the cooling medium to flow into the box.

2. The rechargeable battery as claimed in claim 1, wherein the side inlet openings have different sizes.

3. The rechargeable battery as claimed in claim 1, wherein the side inlet openings are positioned at different distances from one another.

4. The rechargeable battery as claimed in claim 1, wherein the battery box has side inlet openings on at least two opposed sides.

5. The rechargeable battery as claimed in claim 1, wherein the cooling medium is air.

6. The rechargeable battery as claimed in claim 1, wherein at least one outlet opening is integrated in the battery cover.

7. The rechargeable battery as claimed in claim 1, further comprising at least one fan is installed in an outlet opening in the battery cover.
